(19) United States
(12) Patent Application Publication
(10) Pub. No.: US 2015/0304278 A1
(43) Pub. Date: Oct. 22, 2015

(54) SYSTEMS AND METHODS FOR SECURE NETWORK-BASED MONITORING OF ELECTRICAL POWER GENERATORS

(71) Applicant: General Electric Company, Schenectady, NY (US)

(72) Inventors: David N. Johnson, Frenchtown, MT (US); Shawn Christopher Sproule, Virginia Beach, VA (US)

(73) Assignee: General Electric Company, Schenectady, NY (US)

(21) Appl. No.: 14/257,799

(22) Filed: Apr. 21, 2014

(51) Int. Cl. H04L 29/06

(52) U.S. Cl. CPC H04L 63/02

(57) ABSTRACT

A computer-based method for monitoring power generation uses a first computing device including a processor and a memory. The method includes receiving, at the first computing device, controller data from a controller associated with a power generator. The first computing device and the controller are coupled in two-way communication. The method also includes transmitting the controller data to a second computing device associated with monitoring the power generator. The first computing device transmits the controller data in one-way communication to the second computing device.

### BACKGROUND

The present disclosure relates generally to monitoring electrical power generators and, more specifically, to systems for improving security for network-based monitoring of electrical power generators.

In some known monitoring systems, a power generator and/or a controller of the power generator, such as a turbine controller, is in networked communication with a monitoring system. The controller interacts with the power generator during operation to, among other things, read status data from the power generator and to transmit that data to the monitoring system. The monitoring system may be preconfigured to perform only monitoring operations, but the networked access between the monitoring system and the controller may present a security exposure that could be exploited by an unauthorized individual if access to the monitoring system were compromised. For example, an unauthorized user may be able to penetrate the monitoring system and circumvent the monitoring applications in order to perform control commands to the controller and/or the power generator.

To provide security against some security vulnerabilities, the monitoring system may be isolated to a closed network. For example, a monitoring device may be located on site and coupled to the controller in a network that does not have access to other networks. This solution may solve some of the concerns regarding security vulnerabilities, but may hamper some of the benefits gained via broadly networking the monitoring device, including the potential ability to remotely monitor power generators.

### BRIEF DESCRIPTION

In one aspect, a computer-based method for monitoring power generation is provided. The method uses a first computing device including a processor and a memory. The method includes receiving, at a first computing device, controller data from a controller associated with a power generator. The first computing device and the controller are coupled in two-way communication. The method also includes transmitting the controller data to a second computing device associated with monitoring the power generator. The first computing device transmits the controller data in one-way communication to the second computing device.

In another aspect, a computing system for monitoring power generation is provided. The computing system includes a first computing device programmed to receive controller data from a controller associated with a power generator. The first computing device and the controller are coupled in two-way communication. The first computing device is also programmed to transmit the controller data to a second computing device associated with monitoring the power generator. The first computing device transmits the controller data in one-way communication to the second computing device.

In yet another aspect, at least one non-transitory computer-readable storage media having computer-executable instructions embodied thereon is provided. When executed by at least one processor of a first computing device, the computer-executable instructions cause the processor to receive controller data from a controller associated with a power generator. The first computing device and the controller are coupled in two-way communication. The computer-executable instructions also cause the processor to transmit the controller data to a second computing device associated with monitoring the power generator. The first computing device transmits the controller data in one-way communication to the second computing device.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a general schematic diagram of both an exemplary transmission network and an exemplary electrical power distribution system;

FIG. 2 is a schematic diagram of an exemplary networked environment that may be used to monitor the power generation sites shown in FIG. 1;

FIG. 3 is a block diagram of an exemplary computing system that may be used to monitor the power generator and/or controller shown in FIG. 1;

FIG. 4 is a schematic diagram of an exemplary networked environment that may be used to monitor power generation sites including the power plant and distributed generator shown in FIG. 1;

FIG. 5 is an exemplary data flow diagram illustrating various software components of the LMS and OMS shown in FIGS. 2 and 4, and exemplary aspects of data flow through the external firewall shown in FIGS. 2 and 4;

FIG. 6 is a flow chart of an exemplary method of monitoring power generators such as those shown in FIGS. 1, 4, and 5 using one or more computing devices such as those shown in FIGS. 2-5; and

FIG. 7 illustrates an exemplary configuration of a database within a computing device, along with other related computing components, that may be used during analysis of model parameters as described herein.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings

The singular forms “a”, “an”, and “the” include plural references unless the context clearly dictates otherwise. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that may permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital media, with the sole exception being a transitory, propagating signal.

As used herein, the terms “software” and “firmware” are interchangeable, and include any computer program stored in memory for execution by devices that include, without limitation, mobile devices, clusters, personal computers, workstations, clients, and servers.

The methods and systems described herein facilitate enhanced security in the management and monitoring of electrical power generators and associated controllers. In one embodiment, a gas turbine is managed by a turbine controller at a power generation site, and the turbine controller is monitored remotely by a central management site. The turbine controller provides a suite of control and management functions for configuring and monitoring the gas turbine, including the collection of performance metrics and health data from the power generator. An on-site monitoring device (also referred to herein as a local management server, or just “LMS”) is networked to the controller in two-way communication. In other words, the controller can transmit network data packets to the onsite management server, and the onsite management server can transmit network data packets to the controller.

In the exemplary embodiment, the central management site includes an outside management server, or “OMS”, and a central management server, or “CMS”, that is used to centrally monitor a plurality of power generation sites, including the gas turbine mentioned above. The OMS receives the performance metric and health data from the LMS and transmits the data to the CMS, enabling operators at the central management site to see data about the gas turbine. In some embodiments, the network security of the power generation site is enhanced by deploying a firewall at the power generation site between the LMS and the remote OMS. Further, the firewall only allows communications between the LMS and the OMS to be only one-way UDP (user datagram protocol) traffic from the LMS to the OMS, and only on a particular set of ports. The controller sends the performance metrics and health data to the LMS in two-way communication, and the LMS forwards the performance metrics and health data on to the OMS in one-way communication. As such, the LMS and controller are secured from certain network vulnerabilities by the restriction of inbound traffic, and remote monitoring operations are enabled by the one-way communication and reception of the performance metrics and health data from the power generation site.

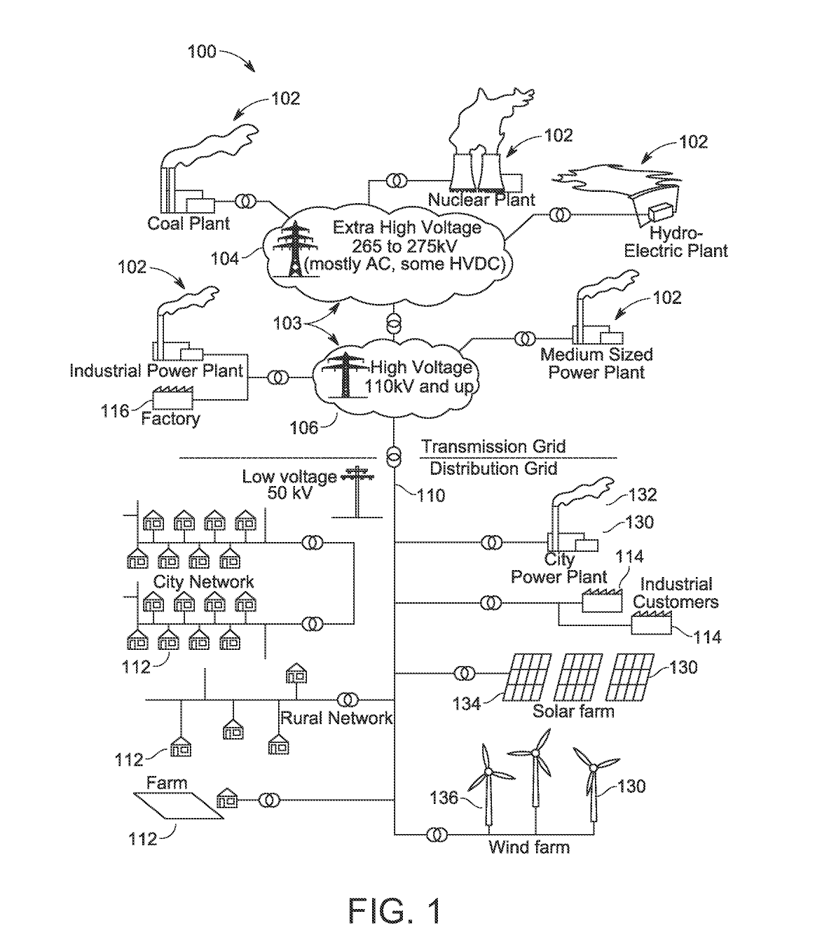

FIG. 1 is a general schematic diagram of an exemplary electrical power network 100 that includes power generation sites that may be monitored with the systems and methods described herein. Electrical power network 100 typically includes power plants 102 outputting power through a transmission grid 103, which includes an extra high voltage transmission grid 104 and a high voltage transmission grid 106 through which power is transmitted to an exemplary electrical power distribution system 110. Each power plant 102 may include one or more power generators and associated controllers (not separately shown in FIG. 1). Electrical power network 100 may include, without limitation, any number, type and configuration of extra high voltage transmission grids 104, high voltage transmission grids 106, and electrical power distribution systems 110, as well as any number of consumers within electrical power distribution system 110, high voltage transmission grid 106, e.g., greater than 110-265 kilovolts (kV), and extra high voltage grid 104, e.g., greater than 265 kV.

Electrical power distribution system 110 includes low wattage consumers 112 and industrial medium wattage consumers 114. Electrical power distribution system 110 also includes distributed generators 130, including a city power plant 132, a solar farm 134, and a wind farm 136. Distributed generators 130 may include one or more power generators and associated controllers (not separately shown in FIG. 1). While electrical power distribution system 110 is shown with an exemplary number and type of distributed generators 130, electrical power distribution system 110 may include any number and type of distributed generators 130, including, without limitation, diesel generators, micro-turbines, solar collector arrays, photo-voltaic arrays, and wind turbines.

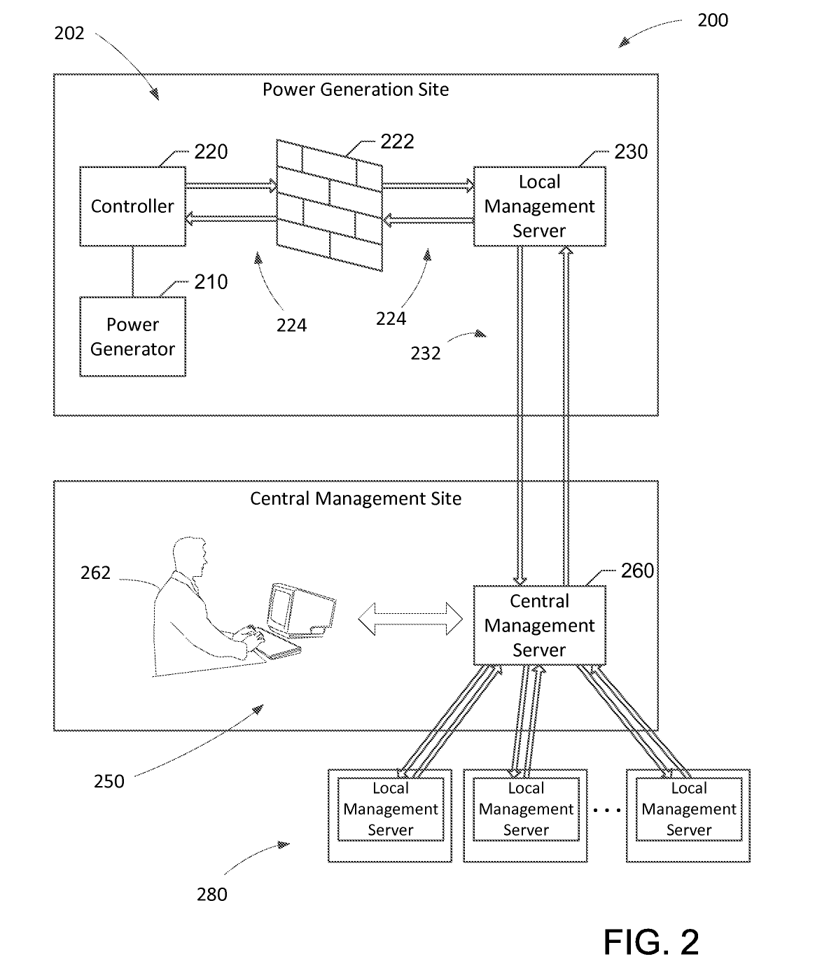

FIG. 2 is a schematic diagram of an exemplary networked environment 200 that may be used to monitor power generation sites such as power plants 102 and distributed generators 130 (both shown in FIG. 1). In the exemplary embodiment, a power generation site 202 includes a power generator 210 such as, for example, a gas turbine, that is used to generate electricity for a transmission network such as transmission grid 106 or a distribution network such as distribution system 110.

In the exemplary embodiment, power generator 210 is communicatively coupled to a controller 220 such as, for example, a gas turbine controller. In some embodiments, controller 220 includes functionalities such as managing operational aspects of power generator 210. In the exemplary embodiment, controller 220 collects data associated with the performance and health of power generator 210. For example, some performance data may be collected from sensors (not shown) of power generator 210 by electrically coupling those sensors to controller 220. As such, controller 220 collects analog and/or digital data associated with various aspects of power generator 210. At least some of this data may be used to monitor performance and health aspects of power generator 210.

To facilitate monitoring of power generator 210, power generation site 202 includes a local management server (“LMS”) 230 coupled in two-way communication with controller 220 across a local network 224. LMS 230 executes a portion of a power generator management application (herein referred to broadly as “the management app”) that facilitates at least monitoring of power generator 210. In the exemplary embodiment, local network 224 is a computer network such as, for example, an Ethernet-based TCP/IP (transmission control protocol/Internet protocol) network. Further, in some embodiments, an internal firewall 222 may be deployed within local network 224 between LMS 230 and controller 220. As such, internal firewall 222 may be used to define which types of communication may occur between LMS 230 and controller 220, thereby allowing enhanced security for controller 220 and local network 224. Internal firewall 222 is configured to enable two-way communication between controller 220 and LMS 230. More specifically, internal firewall 222 is configured to enable the two-way communications required for certain networking protocols to function, such as TCP/IP communications associated with the management app. For example, internal firewall 222 may allow some communications to be initiated from controller 220 to LMS 230, and may allow LMS 230 to respond to controller 220 for that correspondence if required. Further, internal firewall 222 may allow other communications to be initiated from LMS 230 to controller 220, and may also allow controller 220 to respond to LMS 230 for that correspondence if required. In the exemplary embodiment, firewall 222 enables each of the communications between controller 220 and LMS 230 as described below.

In the exemplary embodiment, controller 220 transmits the performance and health data to LMS 320, and the management app. This data is also referred to herein as “tag data.” For example, in some embodiments, tag data includes samples of data from power generator 210, and may include one or more of a sensor identifier, a sensor value, and a timestamp associated with that value. Controller 220 may capture many samples per second and transmit these as tag data to LMS 230. For a single sensor, this series of sample values may be referred to herein as a data stream.

Further, in some embodiments, controller 220 may transmit configuration data to LMS 320 that indicates, for example, what values are being collected (and transmitted) by controller 220. This data is also referred to herein as “tag configuration data.” For example, controller 220 may transmit tag configuration data to LMS 230 indicating one or more unique sensor identifiers for each sensor associated with power generator 210. As such, LMS 320 may automatically configure itself for the particular data streams being collected and sent from controller 220.

In some embodiment, controller 220 also transmits log data to LMS 320. Log data may include, for example, trip logs that are created when a turbine trip occurs, or alarm logs that are created when a controller alarm event occurs. Log data may include pertinent high fidelity data around the time of the log event. Further, in some embodiments, LMS 230 initiates system data interface (SDI) calls to controller 220. SDI is a proprietary message protocol used to communicate with certain turbine controllers.

In the exemplary embodiment, power generation site 202 is communicatively coupled to central management site 250 over an exterior network 232 such as, for example, a private wide-area network (WAN) or the Internet. Central management site 250 includes a central management server (CMS) 260 that is also a part of the management app. CMS 260 may also be communicatively coupled to one or more additional power generation sites 280, each of which may include one or more onsite management servers similar to LMS 230. In the exemplary embodiment, LMS 230 is coupled in two-way communication with CMS 260 similar to that described above. LMS 230 transmits data, such as tag data and/or tag configuration data, to CMS 260. For example, in some embodiments, LMS 230 transmits historian tag data to a central historian server (not shown in FIG. 2) that is a part of or otherwise coupled to CMS 260, and LMS 230 also transmits anomalies to a central anomaly server (not shown in FIG. 2) that is a part of or otherwise coupled to CMS 260. Further, in some embodiments, LMS 230 is communicatively coupled to a central maintenance and configuration server (not separately shown) with which LMS 230 exchanges packages and other data. In some embodiments, administrative users such as operator 262 may remotely connect to LMS 230 through a graphical front end management application such as a web-based interface of LMS 230, or by logging into LMS 230 using a remote desktop application. As such, users may remotely view the data in the local historian (not separately shown) of LMS 230, view controller log files, or perform maintenance on LMS 230.

During operation, an operator 262 or other device monitoring personnel monitor multiple power generators such as power generator 210 through CMS 260. Operator 262 may, for example, perform condition-based monitoring such that when there are trip events or other types of alarm events, operator 262 may attempt to determine the cause of the event and report event details back to management personnel at power generation site 202.

While the exemplary embodiment is illustrated with one power generator, one controller, and one OSM, it should be understood that multiple power generators and controllers may be monitored by an OSM, and many OSMs may be present at a given power generation site. Further, it should be understood that many types of power generators and controllers may be monitored by an OSM.

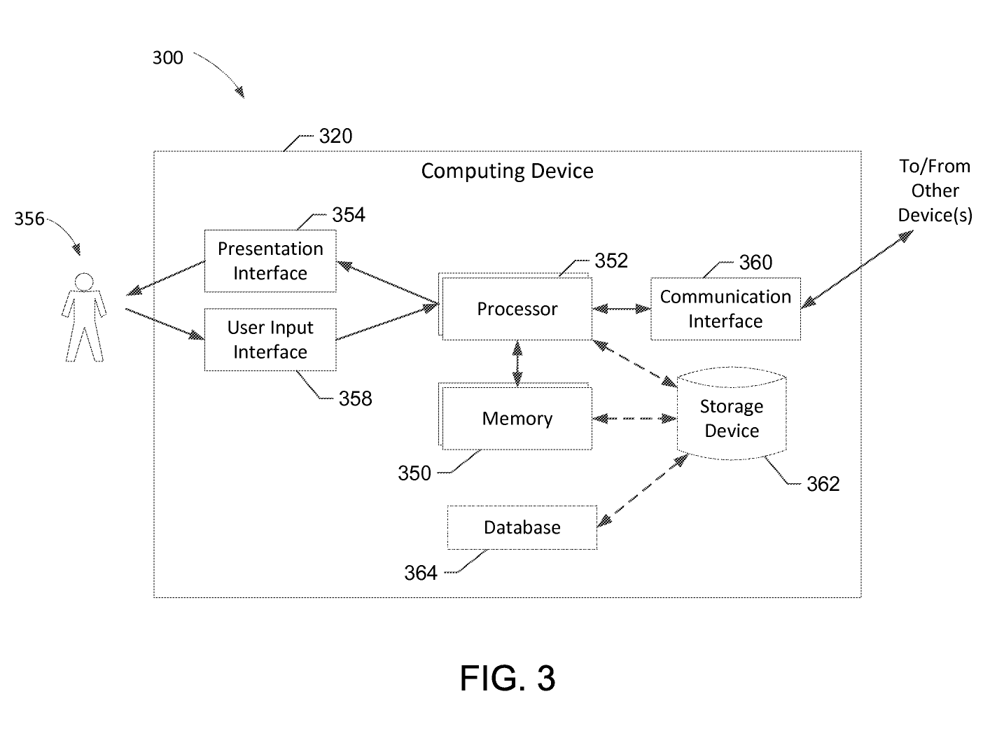

FIG. 3 is a block diagram 300 of an exemplary computing system 320 that may be used to monitor power generators and/or controllers such as power generator 210 and controller 220 (both shown in FIG. 1). In some embodiments, computing system 320 may be LSM 230, internal firewall 222, or CMS 260 (all shown in FIG. 1). Alternatively, any computer architecture that enables operation of computing system 320 as described herein may be used.

In the exemplary embodiment, computing system 320 includes a memory device 350 and a processor 352 operatively coupled to memory device 350 for executing instructions. In some embodiments, executable instructions are stored in memory device 350. Computing system 320 is configurable to perform one or more operations described herein by programming processor 352. For example, processor 352 may be programmed by encoding an operation as one or more executable instructions and providing the executable instructions in memory device 350. Processor 352 may include one or more processing units, e.g., without limitation, in a multi-core configuration.

Further, in the exemplary embodiment, memory device 350 is one or more devices that enable storage and retrieval of information such as executable instructions and/or other data. Memory device 350 may include one or more tangible, non-transitory computer-readable media, such as, without limitation, random access memory (RAM), dynamic random access memory (DRAM), static random access memory (SRAM), a solid state disk, a hard disk, read-only memory (ROM), erasable programmable ROM (EPROM), electrically erasable programmable ROM (EEPROM), and/or non-volatile RAM (NVRAM) memory. The above memory types are exemplary only, and are thus not limiting as to the types of memory usable for storage of a computer program.

Also, in the exemplary embodiment, memory device 350 may be configured to store a variety of monitoring data associated with power generator 210 and/or controller 220 such as, for example, values or other data associated with temperature, pressure, vibration, fuel flow, controller settings, and other constants.

In some embodiments, computing system 320 includes a presentation interface 354 coupled to processor 352. Presentation interface 354 presents information, such as a user interface and/or an alarm, to a user 356. For example, presentation interface 354 may include a display adapter (not shown) that may be coupled to a display device (not shown), such as a cathode ray tube (CRT), a liquid crystal display (LCD), an organic LED (OLED) display, and/or a hand-held device with a display. In some embodiments, presentation interface 354 includes one or more display devices. In addition, or alternatively, presentation interface 354 may include an audio output device (not shown), e.g., an audio adapter and/or a speaker.

In some embodiments, computing system 320 includes a user input interface 358. In the exemplary embodiment, user input interface 358 is coupled to processor 352 and receives input from user 356. User input interface 358 may include, for example, a keyboard, a pointing device, a mouse, a stylus, and/or a touch sensitive panel, e.g., a touch pad or a touch screen. A single component, such as a touch screen, may function as both a display device of presentation interface 354 and user input interface 358.

Further, a communication interface 360 is coupled to processor 352 and is configured to be coupled in communication with one or more other devices such as, without limitation, another computing system 320, one or more controllers 220 and/or power generators 210, one or more firewalls such as internal firewall 222, one or more CMS's 260, and any device capable of accessing computing system 320 including, without limitation, a portable laptop computer, a personal digital assistant (PDA), and a smart phone. Communication interface 360 may include, without limitation, a wired network adapter, a wireless network adapter, a mobile telecommunications adapter, a serial communication adapter, and/or a parallel communication adapter. Communication interface 160 may receive data from and/or transmit data to one or more remote devices. Computing system 120 may be web-enabled for remote communications, for example, with a remote desktop computer (not shown).

Also, presentation interface 354 and/or communication interface 360 are both capable of providing information suitable for use with the methods described herein, e.g., to user 356 or another device. Accordingly, presentation interface 354 and communication interface 360 may be referred to as output devices. Similarly, user input interface 358 and communication interface 360 are capable of receiving information suitable for use with the methods described herein and may be referred to as input devices.

Further, processor 352 and/or memory device 350 may also be operatively coupled to a storage device 362. Storage device 362 is any computer-operated hardware suitable for storing and/or retrieving data, such as, but not limited to, data associated with a database 364. In the exemplary embodiment, storage device 362 is integrated in computing system 320. For example, computing system 320 may include one or more hard disk drives as storage device 362. Moreover, for example, storage device 362 may include multiple storage units such as hard disks and/or solid state disks in a redundant array of inexpensive disks (RAID) configuration. Storage device 362 may include a storage area network (SAN), a network attached storage (NAS) system, and/or cloud-based storage. Alternatively, storage device 362 is external to computing system 320 and may be accessed by a storage interface (not shown).

Moreover, in the exemplary embodiment, database 364 contains a variety of static and dynamic operational data associated with monitoring power generators 210.

The embodiments illustrated and described herein as well as embodiments not specifically described herein but within the scope of aspects of the disclosure, constitute exemplary means for securely monitoring power generators 210. For example, computing system 120, and any other similar computer device added thereto or included within, when integrated together, include sufficient computer-readable storage media that is/are programmed with sufficient computer-executable instructions to execute processes and techniques with a processor as described herein. Specifically, computing system 120 and any other similar computer device added thereto or included within, when integrated together, constitute an exemplary means for securely monitoring power generators 210.

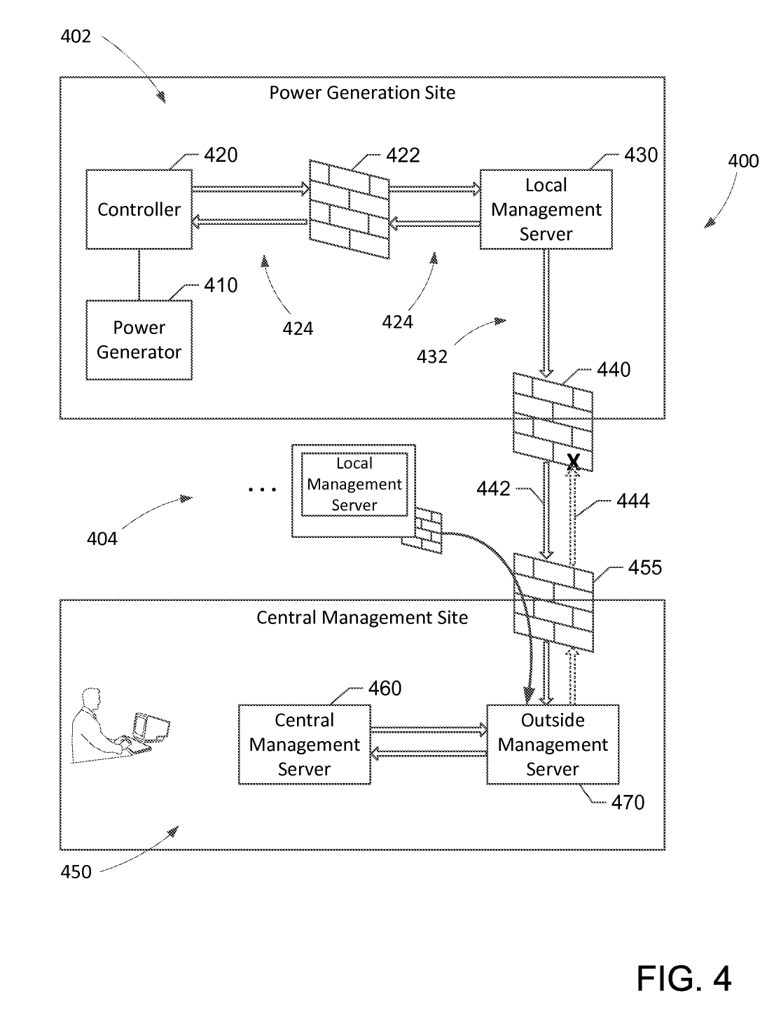

FIG. 4 is a schematic diagram of an exemplary networked environment 400 that may be used to monitor power generation sites such as power plants 102 and distributed generators 130 (both shown in FIG. 1). In some embodiments, networked environment 400 is similar to networked environment 200 (shown in FIG. 2). In the exemplary embodiment, a power generation site 402 includes a power generator 410 such as, for example, a gas turbine, that is used to generate electricity for a transmission network such as transmission grid 106 or a distribution network such as distribution system 110.

In the exemplary embodiment, power generator 410 is communicatively coupled to a controller 420 such as, for example, a gas turbine controller. In some embodiments, controller 420 is similar in function to controller 220 as described above in reference to FIG. 2. Further, power generation site 402 also includes a local management server (LMS) 430 and an internal firewall 422. In some embodiments, LMS 430 is similar to LMS 230 (shown in FIG. 2) and internal firewall 422 is similar to internal firewall 222 (shown in FIG. 2) as described above in reference to FIG. 2. In the exemplary embodiment, LMS 430 and controller 420 are coupled in two-way communication across an internal network 424 similar to the communications relationship of LMS 230 and controller 220 as described above in reference to FIG. 2.

Further, in the exemplary embodiment, power generation site 402 includes an external firewall 440 that routes traffic from LMS 430 to an external or outside management server (OMS) 470. In the exemplary embodiment, OMS 470 is physically located at a central management site 450 with a central management server (CMS) 460, and also executes a portion of the management app. In some embodiments, CMS 450 is similar in functionality to CMS 250 as shown and described and described above in reference to FIG. 2. In some embodiments, central management site 450 may include a perimeter firewall 455 that is configured to enable traffic from LMS 430 and other local management servers from other power generation sites 404 as described herein.

LMS 430 and OMS 470, in the exemplary embodiment, are configured in one-way communication. More specifically, external firewall 440 is configured to allow LMS 430 to send outbound data packets 442 across network 432 to OMS 470, but is configured to reject, deny, drop, or otherwise disallow inbound data packets 444 associated with the management app executing on LMS 430. As used herein, the term “disallow,” as used with regard to data packets, is used generally to refer to a firewall rejecting, denying, dropping, ignoring, or otherwise not forwarding a data packet.

In some embodiments, outbound packets 442 are UDP packets transmitted by the management app from LMS 430, and external firewall 440 is configured to allow outbound UDP packets from LMS 430 (e.g., where the source IP address of the data packets is an IP address associated with LMS 430 and the protocol type of the packet is UDP). The UDP protocol is a unidirectional protocol, thus there is no return transmission required from the receiver (e.g., no receipt acknowledgment required). While UDP is described in these exemplary embodiments, it should be understood that other unidirectional protocols are possible and within the scope of this disclosure.

For example, presume LMS 430 includes one network interface card (NIC) coupled to internal network 424 and hosting a single network address A (e.g., internal network 424 is the same as network 432). The management app on LMS 430 may define an inbound TCP/IP port of 9876 that LMS 430 uses for inbound communications from, for example, controller 420. In other words, the management app and LMS 430 are ‘listening’ on port 9876 of NIC A. Thus, any inbound connections to LMS 430 on port 9876 of NIC A may be answered by the management app. For example, controller 420 may initiate and transmit communications with LMS 430 on, for example, address A port 9876. To limit at least some security vulnerabilities associated with the management app, external firewall 440 disallows all inbound data packets 444 destined for port 9876 of NIC A of LMS 430. As such, in the exemplary embodiment, all inbound communications 444 received by external firewall 440 indicating a source or destination address and port of NIC A port 9876 of LMS 430 are disallowed (e.g., not allowing any external devices to initiate or otherwise transmit packets to LMS 430 on port 9876, but still allowing communications on other ports such as ports not associated with the management app). In other embodiments, all inbound communications 444 received by external firewall 440 indicating NIC A of LMS 430 are disallowed (e.g., not allowing any packets 444 to come in to LMS 430, regardless of what app or port is involved, and regardless of whether LMS 430 initiated the communication).

In other embodiments, LMS 430 may include a plurality of NICs. For example, LMS 430 may include a first NIC with a first IP address A on internal network 424 and a second NIC with a second IP address B on network 432. As such, two-way communications between LMS 430 and controller 420 occurs on the first NIC using IP address A, but outbound one-way communications to OMS 470 occurs on the second NIC using IP address B (e.g., outbound UDP traffic 442 routes through network 432 to external firewall 440 and on to OMS 470). Accordingly, external firewall 440 may block incoming data packets 444 for IP address B, and optionally IP address A as well. Further, external firewall 440 may also block on ports and/or traffic types similar to other embodiments.

In still other embodiments, LMS 430 may include one NIC hosting multiple IP addresses (e.g., addresses A and B). LMS 430 and controller 420 may communicate two-way traffic with each other using IP address A, while LMS 430 transmits one-way traffic to OMS 470 using address B. Accordingly, external firewall 440 may block incoming data packets 444 for IP address B, and optionally IP address A as well. Further, external firewall 440 may also block on ports and/or traffic types similar to other embodiments.

Additionally, external firewall 440 may perform IP masking, or “network address translation” (NAT). As such, the outbound packets 442 from LMS 430 may be altered by external firewall 440 to reflect a source IP address of something other than an actual IP address of LMS 430 (i.e., the NAT address). As such, inbound traffic 444 to the NAT address may also be blocked by external firewall 440.

Further, in some embodiments, external firewall 440 may allow multiple one-way communications streams from LMS 430 to OMS 470. In the exemplary embodiment, OMS 470 receives two data streams from LMS 430 on two separate TCP ports of OMS 470. LMS 430 transmits one data stream consisting of controller data being replicated to OMS 470 (e.g., tag data), and another data stream consisting of file data being replicated to OMS 470 (e.g., file system data from a local file system of LMS 430).

In the exemplary embodiment, internal firewall 422 and external firewall 440 are separate devices. In some embodiments, external firewall 440 and internal firewall 422 may be the same device.

Further, in the exemplary embodiment shown in FIG. 4, OMS 470 is a remote computing device, i.e., not physically residing on site at power generation site 402. In other embodiments, OMS 470 may physically reside at power generation site 402. As such, firewall 440 is disposed between LMS 430 and OMS 470 as described above, i.e., still residing on an external side of firewall 440 relative to LMS 430, and there may or may not be a firewall such as firewall 455 disposed between OMS 470 and CMS 460.

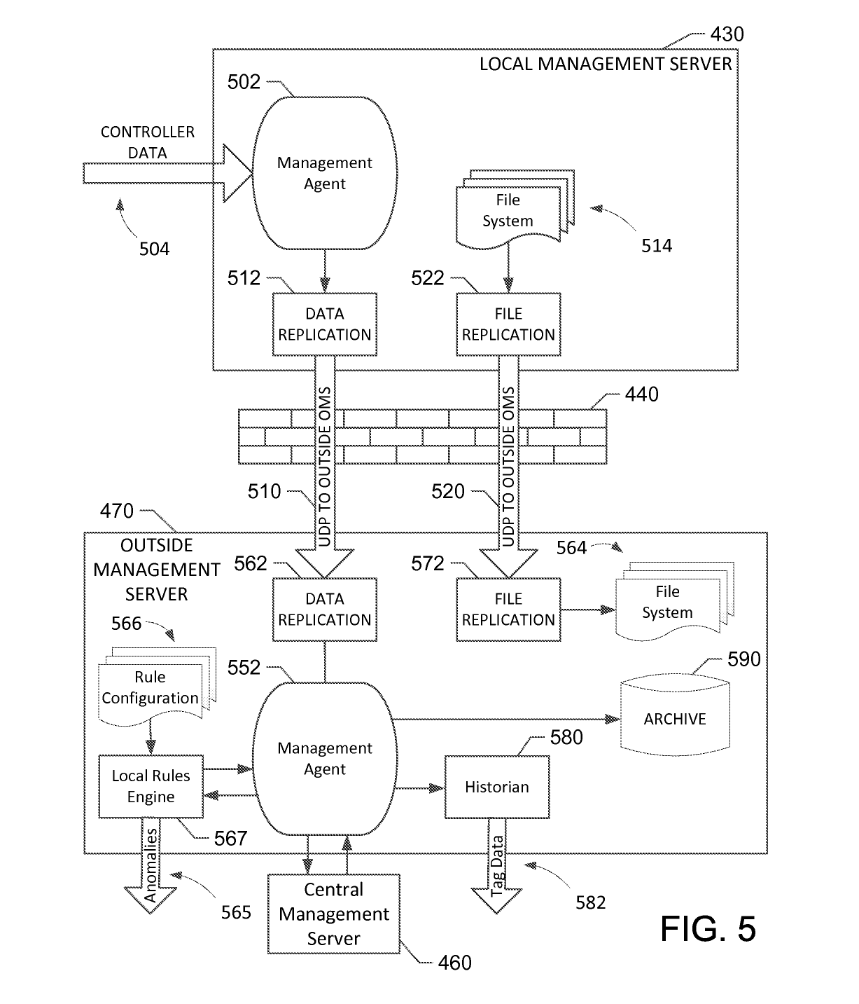

FIG. 5 is an exemplary data flow diagram illustrating various software components of LMS 430 and OMS 470 (e.g., some components of the management app), and exemplary aspects of data flow through external firewall 440. In the exemplary embodiment, LMS 430 includes a management agent 502 that receives controller data 504 from one or more power generators and/or controllers such as power generator 410 and controller 420 (both shown in FIG. 4). LMS also includes a local file system 514 that stores data such as, for example, configuration files used for monitoring turbines, software configuration and log files that are used for monitoring the software of LMS 430, and log files such as controller trip logs and alarm logs.

In the exemplary embodiment, LMS 430 includes a data replication component 512 and a file replication component 522. Data replication component 512 transmits controller data 510, such as described above in reference to FIG. 4, to a data replication component 562 on OMS 470. More specifically, data replication component 512 transmits controller data using UDP protocol to a single port on OMS 470 monitored by data replication component 562. File replication component 522 transmits file replication data 520, such as described above in reference to FIG. 4, to a file replication component 572 on OMS 470. More specifically, file replication component 522 transmits controller data using UDP protocol to another single port on OMS 470 monitored by file replication component 572.

External firewall 440, in the exemplary embodiment, is configured to enable controller data 510 and file replication data 520 on the two UDP ports to at least OMS 470. Further, external firewall 440 disallows traffic from OMS 470 back to LMS 430. In some embodiments, external firewall 440 disallows traffic on one or more ports associated with management agent 502 and/or controller data 504.

OMS 470, in the exemplary embodiment, includes a management agent 552 that communicates with a number of other components during operation. OMS 470 includes a rules engine 567 and an associated rules configuration 566 for detecting anomalies 565 within controllers and/or power generators (e.g., within the replicated controller data 510). In some embodiments, controller data 510 replicated from LMS 430 is processed by local rules engine 567 and/or a central rules engine (not separately shown) of CMS 460. These rules engines analyze controller data 510 for anomalies or other conditions such as, for example, trips, unexpected temperatures or pressures, and high vibration. OMS 470 also includes a historian component 580 for storing tag data in a compressed format for later use and analysis. In some embodiments, OMS 470 includes an archive 590 for storing compressed data files stored by historian component 580. OMS 470 and/or CMS 460 may include historian components.

During operation, OMS 470 receives replicated controller data 510 from LMS 430 through data replication component 562. Controller data 510 is distributed by management agent 552 to various other components as described above. File replication data 520 is received by file replication component 572 and stored in a local file system 564 of OMS 470.

In the exemplary embodiment, management agent 552 is in communication with central management server 460. Management agent 552 is a configuration and maintenance (C&M) software component on LMS 430 that communicates C&M packages to a central agent (not separately shown) of CMS 460 for processing. CMS 460 transmits C&M packages to management agent 552 to configure or perform maintenance on OMS 470.

As used herein, the terms “local” or “internal” are used to describe LMS 430 in relation to a local network such as network 424 (shown in FIG. 4) and, more particularly, in relation to how LMS 430 is networked in relation to firewall 440 and OMS 470. In some embodiments, network 424 may be considered an “internal” network because, for example, it is protected from communications of other networks by firewall 440. Thus LMS 430 may be referred to as a local computing device or an internal computing device because, for example, it is on a trusted side of firewall 440. Similarly, the term “external” is used to describe OMS 470 in relation to the same local network (e.g., internal network 424) and, more particularly, in relation to how OMS 470 is networked in relation to firewall 440 and LMS 430. OMS 470 may be referred to as an external computing device because, for example, it is on an un-trusted side of firewall 440.

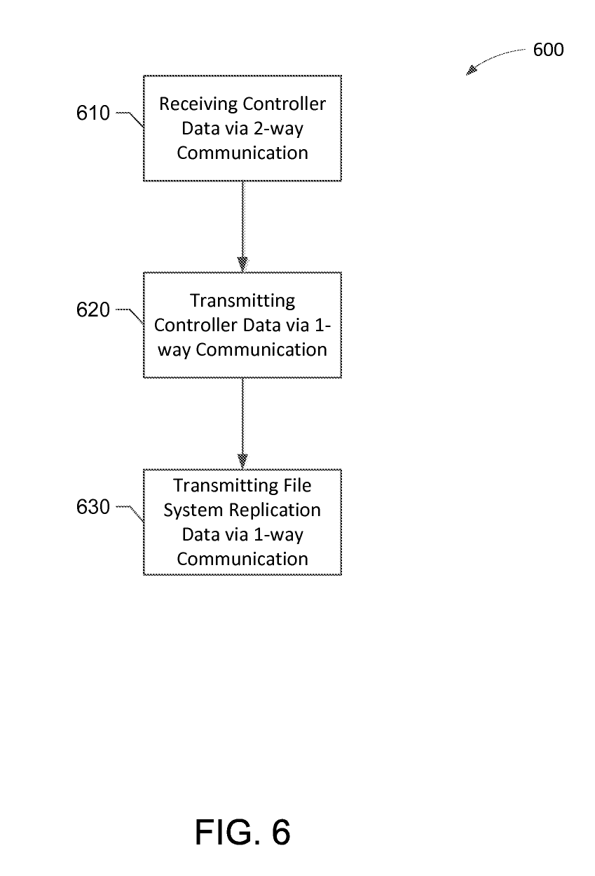

FIG. 6 is a flow chart of an exemplary method 600 of monitoring power generators such as those shown in FIGS. 1, 4, and 5 using one or more computing devices such as those shown in FIGS. 2-5. In the exemplary embodiment, method 600 includes receiving 610, at a first computing device, controller data from a controller associated with a power generator, wherein the first computing device and the controller are coupled in two-way communication. In some embodiments, receiving 610 controller data includes receiving and transmitting TCP/IP data packets between the first computing device and the controller.

In the exemplary embodiment, method 600 also includes transmitting 620 the controller data to a second computing device associated with monitoring the power generator, wherein the first computing device transmits the controller data in one-way communication to the second computing device. In some embodiments, transmitting the controller data to the second computing device includes transmitting UDP data packets from the first computing device to the second computing device. In other embodiments, transmitting the controller data to the second computing device further includes transmitting the controller data to a firewall device for forwarding to the second computing device, wherein the first computing device is on an internal network relative to the firewall and the second computing device is on an external network relative to the firewall. Further, in some embodiments, transmitting the controller data to a remote computing device further includes transmitting the controller data to a firewall device that disallows return traffic associated with the transmittal. In other embodiments, transmitting the controller data to a remote computing device further includes transmitting the controller data to a firewall device that disallows traffic from the second computing device to the first computing device.

In some embodiments, the first computing device includes a file system, and method 600 further includes transmitting 630 file system replication data to the second computing device, wherein the first computing device transmits the file system replication data in one-way communication to the second computing device.

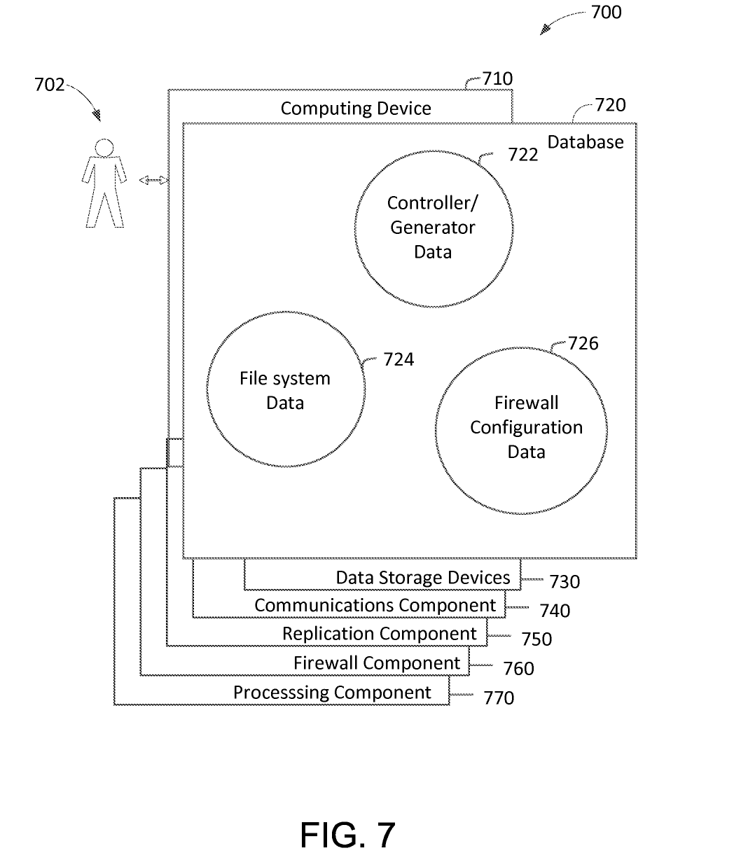

FIG. 7 illustrates an exemplary configuration 700 of a database 720 within a computing device 710, along with other related computing components, that may be used during analysis of model parameters as described herein. Database 720 is coupled to several separate components within computing device 710, which perform specific tasks. In the exemplary embodiment, computing device 710 may be computing device 320 (shown in FIG. 3) and/or any of the computing devices shown in FIGS. 4 and 5.

In the exemplary embodiment, database 720 includes controller/generator data 722, file system data 724, and firewall configuration data 726. Controller/generator data 722 includes information associated with the configuration, operation, and/or performance of power generators and/or controllers associated with power generators. File system data 724 includes information associated with a local file system of computing device 710 or a remote computing device. Firewall configuration data 726 includes information associated with parameters that are used by a firewall to limit the passage of data traffic.

Computing device 710 includes the database 720, as well as data storage devices 730. Computing device 710 also includes a communications component 740 for operations such as receiving controller/generator data 722 and transmitting replication data to other computing devices. Computing device 710 also includes a replication component 750 for operations such as forming the data to be replicated, and communicating with a remote replication component. A firewall component 760 is also included for operations such as allowing outbound traffic from computing device 710 and blocking inbound traffic to computing device 710. A processing component 770 assists with execution of computer-executable instructions associated with the system.

The embodiments illustrated and described herein, as well as embodiments not specifically described herein, but, within the scope of aspects of the disclosure, constitute exemplary means for improved security in the network-based monitoring of power generators. For example, computing device 320, and any other similar computer device added thereto or included within, when integrated together, include sufficient computer-readable storage media that is/are programmed with sufficient computer-executable instructions to execute processes and techniques with a processor as described herein. Specifically, computing device 320 and any other similar computer device added thereto or included within, when integrated together, constitute an exemplary means for improved security in the network-based monitoring of power generators.

The above-described systems and methods provide a way to improved security in the network-based monitoring of power generators. Electrical power generators are monitored by a system of computers, some of which are on site with or local to the power generation site, others of which are remote or otherwise external to the trusted internal network of the power generation site. In some embodiments, one party may manage the power generation site, while another party may be responsible for monitoring aspects for the power generators. The embodiments described herein enable a local party to restrict inbound data access through control of a local firewall while still enabling a local monitoring device to transmit important monitoring data out to a remote computing device.

An exemplary technical effect of the methods, systems, and apparatus described herein includes at least one of: (a) receiving monitoring data from a power generator in two-way communication; (b) transmitting monitoring replication data out from a local site to an external and/or remote site in one-way communication; and (c) protecting the local site and/or the local computing device by limiting inbound access with a local firewall that may be controlled and configured by a manager of the local site.

Exemplary embodiments of systems and methods for improved security in the network-based monitoring of power generators are described above in detail. The systems and methods described herein are not limited to the specific embodiments described herein, but rather, components of systems and/or steps of the methods may be utilized independently and separately from other components and/or steps described herein. For example, the methods may also be used in combination with other monitoring systems, and are not limited to practice with only the monitoring systems and methods as described herein. Rather, the exemplary embodiments can be implemented and utilized in connection with many other monitoring and communications applications.

Although specific features of various embodiments may be shown in some drawings and not in others, this is for convenience only. In accordance with the principles of the systems and methods described herein, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer-based method for monitoring power generation, said method uses a first computing device including a processor and a memory, said method comprising:
receiving, at the first computing device, controller data from a controller associated with a power generator, wherein the first computing device and the controller are coupled in two-way communication; and
transmitting the controller data to a second computing device associated with monitoring the power generator, wherein the first computing device transmits the controller data in one-way communication to the second computing device.

2. The method of claim 1, wherein the first computing device includes a file system, said method further comprising transmitting file system replication data to the second computing device, wherein the first computing device transmits the file system replication data in one-way communication to the second computing device.

3. The method of claim 1, wherein receiving controller data includes receiving and transmitting TCP/IP data packets between the first computing device and the controller.

4. The method of claim 1, wherein transmitting the controller data to a second computing device includes transmitting UDP data packets from the first computing device to the second computing device.

5. The method of claim 1, wherein transmitting the controller data to a second computing device further includes transmitting the controller data to a firewall device for forwarding to the second computing device, wherein the first computing device is on an internal network relative to the firewall and the second computing device is on an external network relative to the firewall.

6. The method of claim 5, wherein transmitting the controller data to a second computing device further includes transmitting the controller data to a firewall device that disallows return traffic associated with the transmittal.

7. The method of claim 5, wherein transmitting the controller data to a second computing device further includes transmitting the controller data to a firewall device that disallows traffic from the second computing device to the first computing device.

8. A computing system for monitoring power generation, said computing system comprising a first computing device programmed to:
receive controller data from a controller associated with a power generator, wherein the first computing device and the controller are coupled in two-way communication; and
transmit the controller data to a second computing device associated with monitoring the power generator, wherein the first computing device transmits the controller data in one-way communication to the second computing device.

9. The computing system of claim 8, wherein the first computing device further includes a file system, wherein the first computing device is further programmed to transmit file system replication data to the second computing device, wherein the first computing device transmits the file system replication data in one-way communication to the second computing device.

10. The computing system of claim 8, wherein receiving controller data includes receiving and transmitting TCP/IP data packets between the first computing device and the controller.

11. The computing system of claim 8, wherein transmitting the controller data to a second computing device includes transmitting UDP data packets from the first computing device to the second computing device.

12. The computing system of claim 8 further comprising a firewall device, wherein transmitting the controller data to a second computing device further includes transmitting the controller data to the firewall device, wherein the firewall device is programmed to forward the controller data to the second computing device, wherein the first computing device is on an internal network relative to the firewall and the second computing device is on an external network relative to the firewall.

13. The computing system of claim 12, wherein the firewall device is configured to disallow return traffic associated with the transmittal.

14. The computing system of claim 12, wherein the firewall device is configured to disallow traffic from the second computing device to the first computing device.

15. At least one non-transitory computer-readable storage media having computer-executable instructions embodied thereon, wherein when executed by at least one processor of a first computing device, the computer-executable instructions cause the processor to:
receive controller data from a controller associated with a power generator, wherein the first computing device and the controller are coupled in two-way communication; and
transmit the controller data to a second computing device associated with monitoring the power generator, wherein the first computing device transmits the controller data in one-way communication to the second computing device.

16. The computer-readable storage media of claim 15, wherein the first computing device includes a file system, wherein the computer-executable instructions further cause the processor to transmit file system replication data to the second computing device, wherein the first computing device transmits the file system replication data in one-way communication to the second computing device.

17. The computer-readable storage media of claim 15, wherein receiving controller data includes receiving and transmitting TCP/IP data packets between the first computing device and the controller.

18. The computer-readable storage media of claim 15, wherein transmitting the controller data to a second computing device includes transmitting UDP data packets from the first computing device to the second computing device.

19. The computer-readable storage media of claim 15, wherein transmitting the controller data to a second computing device further includes transmitting the controller data to a firewall device for forwarding to the second computing device, wherein the first computing device is on an internal network relative to the firewall and the second computing device is on an external network relative to the firewall.

20. The computer-readable storage media of claim 19, wherein the firewall device disallows return traffic associated with the transmittal.
